(19) United States
(12) Patent Application Publication
(10) Pub. No.: US 2015/0351416 A1
(43) Pub. Date: Dec. 10, 2015

(54) ROTARY DIE ASSEMBLIES, METHODS FOR USING SAME, AND FOOD PRODUCTS MADE BY SAME

(71) Applicant: NESTEC SA, Vevey (CH)

(72) Inventors: Fanny Bigeard, Hamelet (FR); Michael E. Leiweke, Hillsboro, MO (US); Pierre Reynes, Camon (FR); Laurent Sisiak, VILLERS BRETONNEUX (FR)

(21) Appl. No.: 14/725,326

(22) Filed: May 29, 2015

Related U.S. Application Data
(60) Provisional application No. 62/008,038, filed on Jun. 5, 2014.

(51) Int. Cl. A21D 13/00; A23L 1/00; B29C 47/06; A23P 1/12

(52) U.S. Cl. CPC A21D 13/0038; A23P 1/12; A23L 1/0073; A23L 1/007; A23P 1/125; B29C 47/06; A23V 2002/00; B29L 2031/00

(57) ABSTRACT

A food product can be formed by injecting a first edible material into an assembly and discharging, from the assembly, the first edible material as straight strands substantially parallel to each other and as helical strands that overlap the straight strands. The straight and helical strands of the first edible material form a lattice structure of the food product. A rotary extrusion die system and a method that provide the food product are also disclosed, as well as other food products and a rotary extrusion die system and a method that provide the other food products.

### CROSS REFERENCE TO RELATED APPLICATIONS

This application claims priority to U.S. Provisional Application No. 62/008,038 filed Jun. 5, 2014, the disclosure of which is incorporated herein by this reference.

### BACKGROUND

The present disclosure relates generally to rotary die assemblies for the formation of food products. More specifically, the present disclosure is directed to rotary die assemblies that can be attached to an extruder-cooker or a high pressure pump that provide edible material, such as cooked dough, for shaping into food products by the rotary die assemblies.

Extrusion is a technique used in the food industry to form shapes by shearing a material that is also subjected to high-temperature and/or pressure. The process parameters can be modulated to generate different types of final products. Extrusion can create a variety of textures and shapes starting from various raw materials. Food products such as pastas, snack foods, breakfast cereals, ice creams, confectioneries, and pet foods are mostly manufactured by extrusion.

An extruder typically includes a power supply to operate one or two screws, a feeder to meter in the raw ingredients, and a barrel which surrounds the screws. The screws are designed to induce compression, generate shear stresses, and convey the raw material. Liquid ingredients and water can be injected into the barrel depending on the desired final product. A cooking process may also take place within the extruder where the product produces its own friction and heat due to the pressure generated. Barrel section temperatures are controlled by induction belts for heating and by water circulation for cooling. Finally, the food ingredients are forced through the extruder toward a shaped hole called the die which shapes the food product.

### SUMMARY

In a general embodiment, the present disclosure provides an assembly that forms a food product. The assembly comprises a fixedly positioned insert comprising first grooves that extend to a discharge end of the assembly; and a rotary insert comprising second grooves that extend to the discharge end of the assembly, and the rotary insert is configured to rotate relative to the fixedly positioned insert.

In an embodiment, the assembly comprises a chamber in fluid communication with both the first grooves and the second grooves.

In an embodiment, the first grooves are arranged along a circle that is concentric to a circle along which the second grooves are arranged, and the center of the circles lies on the axis of rotation of the rotary insert.

In an embodiment, the fixedly positioned insert extends along the axis of rotation of the rotary insert, and the first grooves are positioned along a circumference of an external surface of the fixedly positioned insert.

In an embodiment, the rotary insert surrounds at least a portion of the fixedly positioned insert, and the second grooves are positioned along a circumference of an internal surface of the rotary insert.

In an embodiment, one of the fixedly positioned insert or the rotary insert comprises an internal channel that extends to the discharge end of the assembly.

In an embodiment, the assembly comprises an injection inlet to which an extruder is attached.

In an embodiment, the assembly comprises first apertures and second apertures in the discharge end, the first apertures formed by the first grooves and an interior surface of the rotary insert, and the second apertures formed by the second grooves and an exterior surface of the fixedly positioned insert.

In another embodiment, the present disclosure provides a method of forming a food product. The method comprises injecting a first edible material into an assembly; discharging, from the assembly, the first edible material as straight strands and as helical strands; and forming the food product from the straight and helical strands of the first edible material.

In an embodiment, the straight strands of the first edible material are discharged substantially concurrently relative to the helical strands of the first edible material.

In an embodiment, the first edible material is continuously injected into the assembly and continuously discharged from the assembly during formation of the food product.

In an embodiment, the discharging of the first edible material as the straight strands comprises discharging a portion of the first edible material from grooves in a part of the assembly that is fixedly positioned in the assembly.

In an embodiment, the method comprises rotating a part of the assembly while injecting and discharging the first edible material, and the discharging of the first edible material as the helical strands comprises discharging a portion of the first edible material from grooves in the rotating part of the assembly.

In an embodiment, the method comprises discharging air into a central position relative to the straight and spiraled strands.

In an embodiment, the method comprises discharging a second edible material into a central position relative to the straight and spiraled strands.

In another embodiment, the present disclosure provides a food product comprising straight strands of a first edible material and spiraled strands of the first edible material. The straight strands are arranged substantially parallel to each other and at substantially the same radial distance from a central axis of the food product, and the spiraled strands form a helix around the central axis and overlap the straight strands.

In an embodiment, the spiraled strands are positioned at a greater radial distance from the central axis than the straight strands.

In an embodiment, the food product comprises gaps between the spiraled strands.

In an embodiment, each of the spiraled strands has a length along which the spiraled strand is in contact with adjacent spiraled strands, and the food product comprises an enclosed shell comprising ridges formed by the spiraled strands.

In an embodiment, the food product comprises a second edible material positioned in an interior of the food product.

In an embodiment, the food product comprises kibbles confined in a cavity of the food product.

In an embodiment, the food product comprises the first edible material comprises an ingredient selected from the group consisting of a meat, a flour, and combinations thereof.

In another embodiment, the present disclosure provides an assembly that forms a food product. The assembly comprises: an inner insert comprising an outer perimeter at a discharge end of the assembly; an outer insert comprising an inner perimeter that faces the outer perimeter of the inner insert at the discharge end of the assembly, at least one of the inner insert or the outer insert is configured to rotate relative to the other insert on an axis of rotation; and a gap between the inner perimeter of the outer insert and the outer perimeter of the inner insert at the discharge end of the assembly, the outer insert is distanced from the inner insert by the gap.

In an embodiment, the gap is circular and circumscribes the inner insert at the discharge end of the assembly.

In an embodiment, the inner insert comprises an internal channel that extends along the axis of rotation.

In another embodiment, the present disclosure provides a method of forming an edible shell. The method comprises: injecting a first edible material into an assembly comprising an inner insert and an outer insert; discharging the first edible material from the assembly by discharging the first edible material from a gap that is between an inner perimeter of the outer insert and the outer perimeter of the inner insert; rotating at least one of the inner insert or the outer insert relative to the other insert while discharging the first edible material from the gap; and forming the edible shell from the first edible material that is discharged from the gap during the rotation.

In an embodiment, the first edible material is continuously injected into the assembly and continuously discharged from the gap during formation of the edible shell.

In an embodiment, the method comprises discharging air into an interior of the shell from a channel in the inner insert.

In an embodiment, the method comprises discharging a second edible material into an interior of the shell from a channel in the inner insert.

In an embodiment, the gap is circular and circumscribes the inner insert.

An advantage of the present disclosure is to provide an improved rotary die assembly.

Another advantage of the present disclosure is to provide uniquely shaped dry or soft-dry petfood treats.

A further advantage of the present disclosure is to use rotation to distribute an edible material evenly in a food product.

Still another advantage of the present disclosure is to provide a rotary die assembly that can be oriented horizontally or vertically.

Yet another advantage of the present disclosure is to provide a rotary die assembly that can receive feed from two sources at the same time.

Another advantage of the present disclosure is to use a device to form an outer solid or lattice shell of material from a first source and to introduce into the shell, from a second source, a gas under pressure, particulates such as petfood kibbles, or a highly viscous meaty filling.

A further advantage of the present disclosure is to provide an extrusion die system that creates lattice-structured food products with both straight and helical strands.

Still another advantage of the present disclosure is to use compressed air to produce an expanded structure of lattice-structured food products.

Yet another advantage of the present disclosure is to use compressed air to prevent collapse of lattice-structured food products.

Another advantage of the present disclosure is to form edible empty shells sealed at both open ends, and the edible shells can be solid or be latticed.

A further advantage of the present disclosure is to form edible shells filled with meaty kibbles and sealed at both open ends, and the edible shells can be solid or be latticed.

Still another advantage of the present disclosure is to provide a rotary die assembly that is not only flexible in terms of number and shape of strands/ribbons dispensed but also in terms of dimensions, for example a very thin diameter for forming a very thin grid in the food product or a very large diameter for forming very large pieces, thereby allowing use of the rotary die assembly in a very large range of applications.

Yet another advantage of the present disclosure is to provide a rotary die assembly that produces a lattice-containing food product for which the size of the gaps in the lattice structure can be adjusted by varying the rotation speed of the rotary component of the assembly.

Another advantage of the present disclosure is to provide a pet treat containing kibbles and having a lattice structure in which the kibbles can be partially seen from the exterior and in which the kibbles can be shaken within the structure to create a noise that can attract the pet.

Still another advantage of the present disclosure is to provide a rotary die assembly for which easily changed components can produce food products having desired characteristics.

Additional features and advantages are described herein and will be apparent from the following Detailed Description and the Figures.

### BRIEF DESCRIPTION OF THE FIGURES

FIG. 1 shows a side perspective exploded view of an embodiment of a rotary die assembly provided by the present disclosure.

FIG. 2 shows a side perspective view of an embodiment of a rotary die assembly provided by the present disclosure.

FIG. 3 shows a plan view of the discharge end of an embodiment of a rotary die assembly provided by the present disclosure.

FIG. 4 shows a plan view of the discharge end of an embodiment of a rotary die assembly provided by the present disclosure.

FIG. 5 shows a plan view of the discharge end of an embodiment of a rotary die assembly provided by the present disclosure.

FIG. 6 shows a plan view of the discharge end of an embodiment of a rotary die assembly provided by the present disclosure.

FIG. 7A shows cross-section views of various pet food products provided by the present disclosure.

FIG. 7B shows a cross-section view of a pet food product provided by the present disclosure.

FIG. 8 shows embodiments of pet food products achieved in Example 1.

FIG. 9 shows an embodiment of pet food products achieved in Example 2.

FIG. 10 shows an embodiment of pet food products achieved in Example 3.

FIG. 11 shows an embodiment of pet food products achieved in Example 4.

FIG. 12 shows an embodiment of pet food products achieved in Example 5.

FIG. 13 shows an embodiment of pet food products achieved in Example 6.

FIG. 14 shows an embodiment of pet food products achieved in Example 6.

FIG. 15 shows an embodiment of pet food products achieved in Example 7.

### DETAILED DESCRIPTION

As used in this disclosure and the appended claims, the singular forms “a,” “an” and “the” include plural referents unless the context clearly dictates otherwise. The words “comprise,” “comprises” and “comprising” are to be interpreted inclusively rather than exclusively. Likewise, the terms “include,” “including” and “or” should all be construed to be inclusive, unless such a construction is clearly prohibited from the context. However, the devices disclosed herein may lack any element that is not specifically disclosed. Thus, a disclosure of an embodiment using the term “comprising” includes a disclosure of embodiments “consisting essentially of” and “consisting of” the components identified.

The term “pet” means any animal which could benefit from or enjoy the food products provided by the present disclosure. The pet can be an avian, bovine, canine, equine, feline, hicrine, lupine, murine, ovine, or porcine animal. The pet can be any suitable animal, and the present disclosure is not limited to a specific pet animal. The term “companion animal” means a dog or a cat.

The term “pet food” means any composition intended to be consumed by a pet. “Dry food” is pet food having a water activity less than 0.65. “Semi-moist food” and “intermediate moisture food” is pet food having a water activity from 0.65 to 0.8. “Wet food” is pet food having a water activity more than 0.8. “Shelf-stable” means stable at ordinary temperatures for at least one year.

“Kibbles” are pieces of dry pet food which can have a pellet shape or any other shape. Non-limiting examples of kibbles include particulates; pellets; pieces of petfood, dehydrated meat, meat analog, vegetables, and combinations thereof; and pet snacks, such as meat or vegetable jerky, rawhide, and biscuits. The present disclosure is not limited to a specific form of the kibbles.

Ranges are used herein in shorthand to avoid listing every value within the range. Any appropriate value within the range can be selected as the upper value or lower value of the range. Moreover, the numerical ranges herein include all integers, whole or fractions, within the range.

All percentages expressed herein are by weight of the total weight of the food composition unless expressed otherwise. When reference is made to the pH, values correspond to pH measured at 25° C. with standard equipment. As used herein, “about” or “substantially” in reference to a number is understood to refer to numbers in a range of numerals, for example the range of −10% to +10%, preferably −5% to +5%, more preferably −1% to +1%, and even more preferably −0.1% to +0.1% of the referenced number.

The methods and compositions and other advances disclosed herein are not limited to particular methodologies, protocols, and reagents because, as the skilled artisan will appreciate, they may vary. Further, the terminology used herein is for the purpose of describing particular embodiments only and does not limit the scope of that which is disclosed or claimed.

Unless defined otherwise, all technical and scientific terms, terms of art, and acronyms used herein have the meanings commonly understood by one of ordinary skill in the art in the field(s) of the present disclosure or in the field(s) where the term is used. Although any compositions, methods, articles of manufacture, or other means or materials similar or equivalent to those described herein can be used, the preferred compositions, methods, articles of manufacture, or other means or materials are described herein.

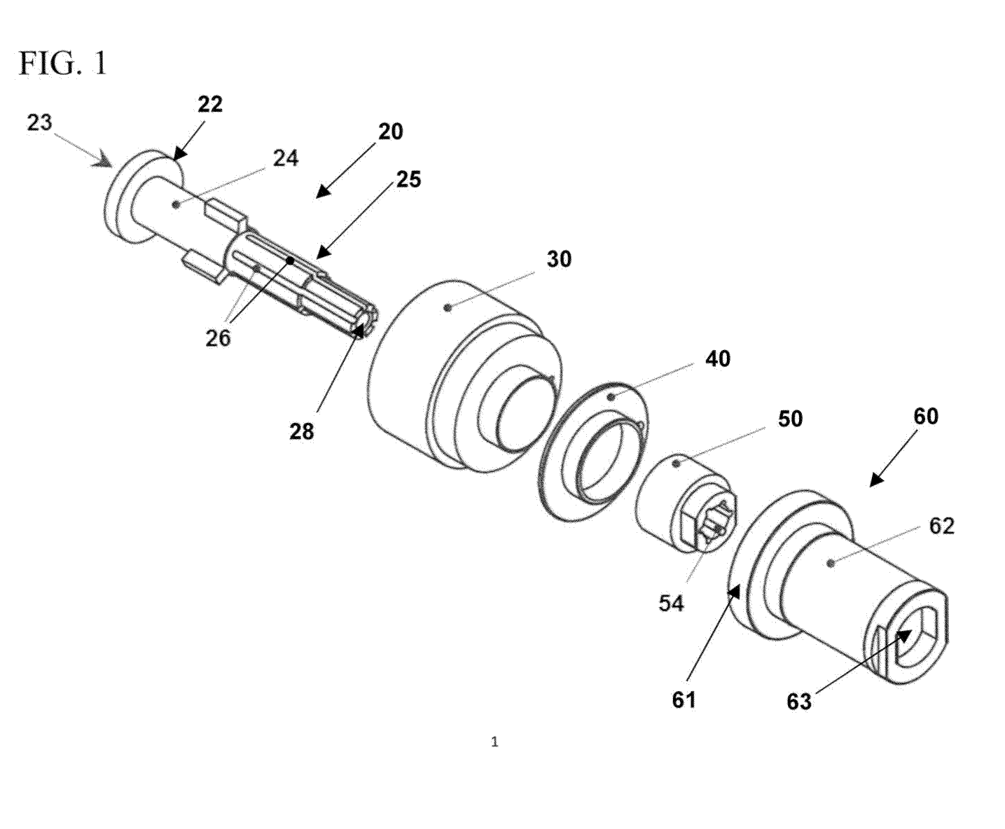

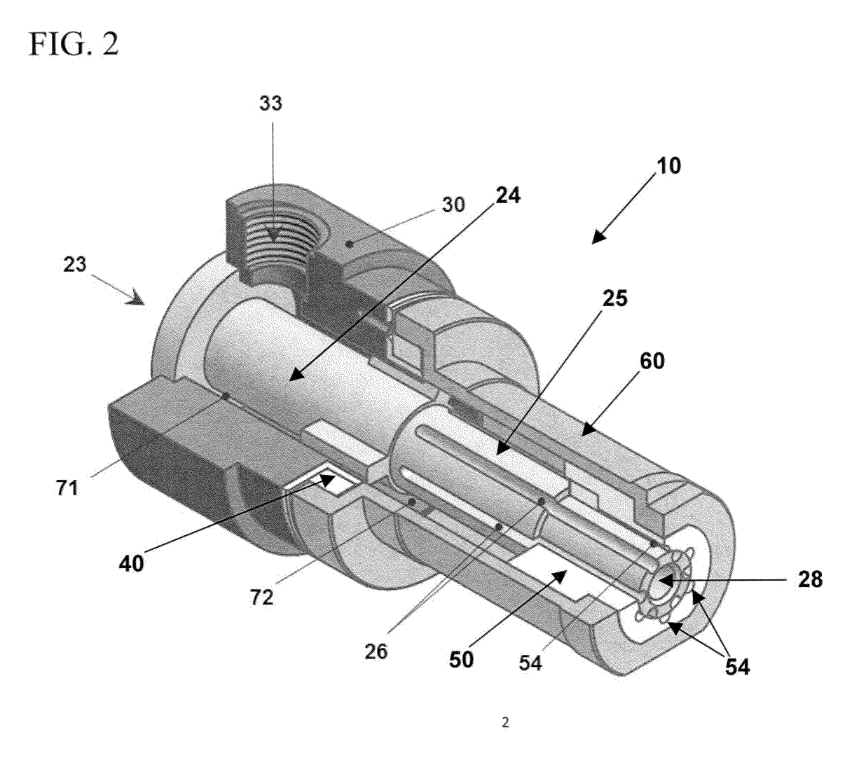

FIGS. 1 and 2 depict an embodiment of a rotary extrusion die system 10 provided by the present disclosure. FIGS. 1 and 2 depict the rotary extrusion die system 10 in a horizontal orientation, but the rotary extrusion die system 10 can be positioned in any other orientation, including vertical.

The rotary extrusion die system 10 can comprise a die stationary part 30 and a rotary insert holder 60. The rotary extrusion die system 10 can comprise an insert system comprising an insert outer part 50 and an insert inner part 20 which can be at least partially positioned within the rotary insert holder 60.

The insert inner part 20 can be fixedly positioned, and the rotary insert holder 60 can rotate relative to the insert inner part 20. The die stationary part 30 can be fixedly positioned, for example by attachment to the insert inner part 20. The die stationary part 30 can comprise an injection inlet 33 into which a first edible material can be injected, such as an extruded material, for example an extruded dough.

The insert inner part 20 can comprise a fixed tube and can comprise a base 22 by which the insert inner part 20 can be fixedly positioned. The insert inner part 20 can comprise a first portion 24 and a second portion 25. The insert inner part 20 can comprise inner grooves 26 on the external surface of the insert inner part 20, for example on the external surface of the second portion 25. The inner grooves 26 can receive a portion of the first edible material to form straight strands of the first edible material. Preferably the inner grooves 26 are evenly spaced from each other. Although FIGS. 1 and 2 depict six of the inner grooves 26, any number of the inner grooves 26 can be used.

The insert outer part 50 can be configured to rotate relative to the insert inner part 20. For example, the insert outer part 50 can be fixedly connected to the rotary insert holder 60 such that rotation of the rotary insert holder 60 can rotate the insert outer part 50. The rotary insert holder 60 and the insert outer part 50 can be rotated relative to the insert inner part 20 by any means known to one of ordinary skill. For example, a device connected to the rotary insert holder 60 can rotate the rotary insert holder 60.

The insert outer part 50 can comprise outer grooves 54 on the internal surface of the insert outer part 50. The outer grooves 54 can receive a portion of the first edible material to form helical strands of the first edible material. The insert outer part 50 can surround at least a portion of the insert inner part 20, which is fixedly positioned, and can rotate to form helically coiled strands of the first edible material around the straight strands of the first edible material. In an embodiment, a lattice grid pattern of the strands is formed. Preferably the outer grooves 54 are evenly spaced from each other. Although FIGS. 1 and 2 depict six of the outer grooves 54, any number of the outer grooves 54 can be used. Preferably the inner grooves 26 and/or the outer grooves 54 each extend in a direction parallel to the axis of rotation of the insert outer part 50.

As further shown in FIGS. 1 and 2, the insert inner part 20 can be hollow with a smooth internal surface. For example, the insert inner part 20 can comprise a channel that extends from an additional injection inlet 23, into which air and/or a second edible material can be injected, to an additional injection outlet 28. Thus the insert inner part 20 can form a cylindrical nozzle for any additional injection, such as a dough filling for co-extrusion and/or compressed air that enhances shaping of the grid pattern and/or limits collapse of the food product structure. The base 22 of the insert inner part 20 can be attached to the device that provides the additional injection.

The gasket 40 can provide a seal between the die stationary part 30 and the insert holder 60. For example, the gasket 40 can comprise a surface complementary to the die stationary part 30 and can comprise a surface complementary to the insert holder 60.

FIG. 2 shows how the first edible material, for example an extruded dough, can flow inside the rotary extrusion die system 10. In an embodiment, the first edible material is injected in the rotary extrusion die system 10 through the injection inlet 33 in the die stationary part 30. The first edible material can be spread around the inner insert part 20 by a first forming chamber 71. For example, the first forming chamber 71 can be at least partially defined by the exterior surface of the inner insert part 20 and the interior surface of the die stationary part 30. In an embodiment, the first forming chamber 71 can be at least partially defined by the exterior surface of the first portion 24 of the inner insert part 20 and the interior surface of the die stationary part 30. The base 22 of the insert outer part 50 can define an end of the first forming chamber 71.

Then the first edible material can move to a second forming chamber 72. For example, the first edible material can be continuously injected into the rotary extrusion die system 10 such that subsequently injected first edible material forces the previously injected first edible material from the first forming chamber 71 to the second forming chamber 72.

The second forming chamber 72 can be at least partially defined by the exterior surface of the inner insert part 20 and the interior surface of the insert holder 60. For example, the second forming chamber 72 can be at least partially defined by the exterior surface of the second portion 25 of the inner insert part 20 and the interior surface of the insert holder 60. At this stage, the first edible material can fill the inner grooves 26 to start forming straight inner strands of the food product.

Then the first edible material can move to the insert outer part 50 which can at least partially define a discharge end of the second forming chamber 72. At this stage, the first edible material can fill the outer grooves 54 and can form external strands surrounding the straight inner strands from the inner grooves 26. A spiraled lattice effect of the external strands can be provided by rotation of the insert outer part 50 around the insert inner part 20. The second edible material and/or air can emerge from the additional injection outlet 28 into a central position relative to the straight inner strands and the external spiraled strands, for example as a filling or as support for the strands.

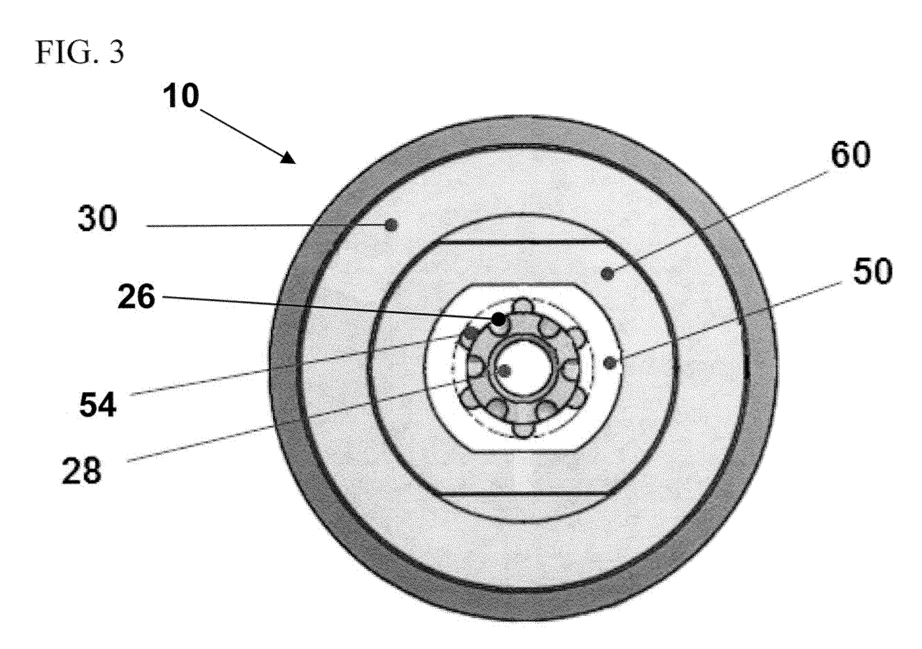

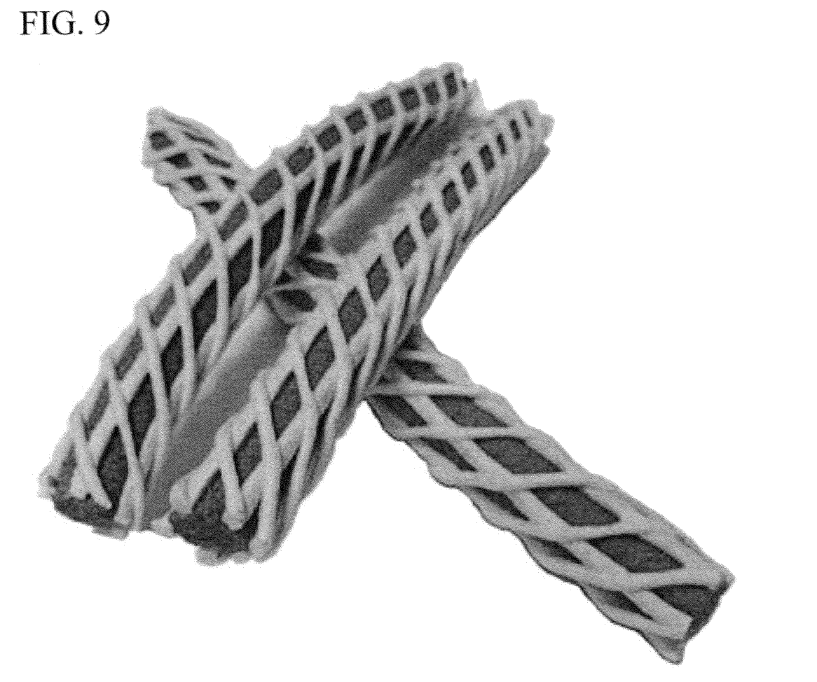

FIG. 3 shows a view of the discharge end of the rotary extrusion die system 10. The inner grooves 26 and the inner surface of the outer insert part 50 can form apertures through which the straight inner strands are discharged, and the outer grooves 54 and the outer surface of the inner insert part 20 can form apertures through which the spiraled outer strands are discharged. When the inner grooves 26 radially align with the outer grooves 54 during rotation of the insert outer part 50, the external spiraled strands can overlap the straight inner strands (as a non-limiting example, see FIG. 9).

The speed of rotation of the insert outer part 50 can be varied to obtain a desired cosmetic appearance of the food product. For example, slower speeds of rotation of the insert outer part 50 can create distinct strands of the first edible material which are distanced from each other to create gaps, and faster speeds of rotation of the insert outer part 50 can create a continuous shell of the first edible material in which ridges are formed.

A suitable sealing and cutting device, such as a one or more of a crimper, a rotary knife, an ultra-sonic knife, a counter-blade, or the like may be mounted at the discharge end of the rotary extrusion die system 10 or proximate thereto. The sealing and cutting device can process the discharged first edible material, along with any of the second edible material and/or air, into food products of a desired size. The length of the discharged first edible material that passes by the sealing and cutting device between uses thereof can be adjusted to achieve the desired size of the food product.

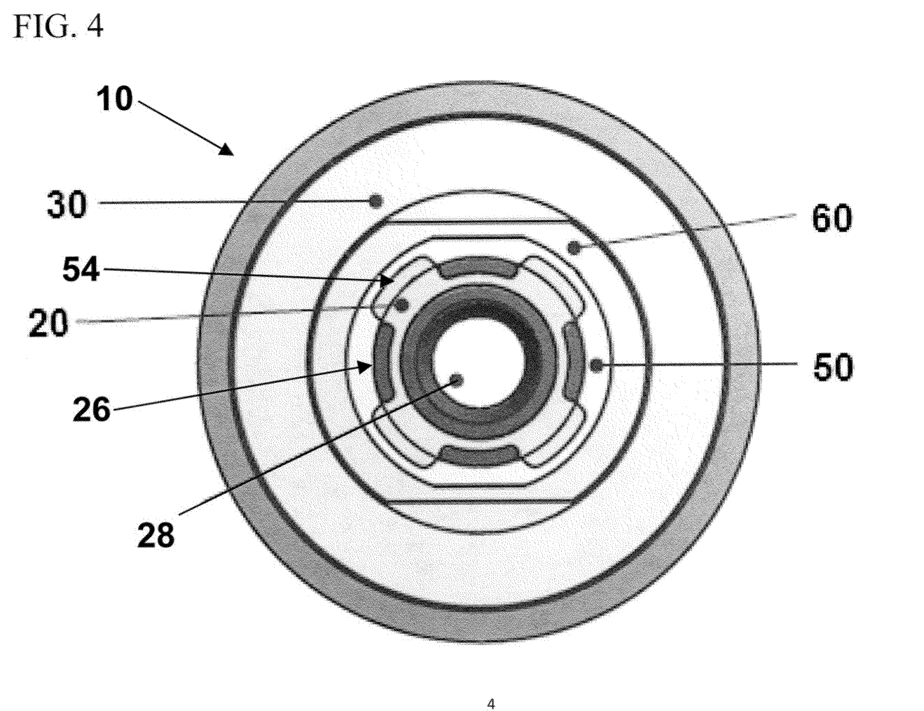

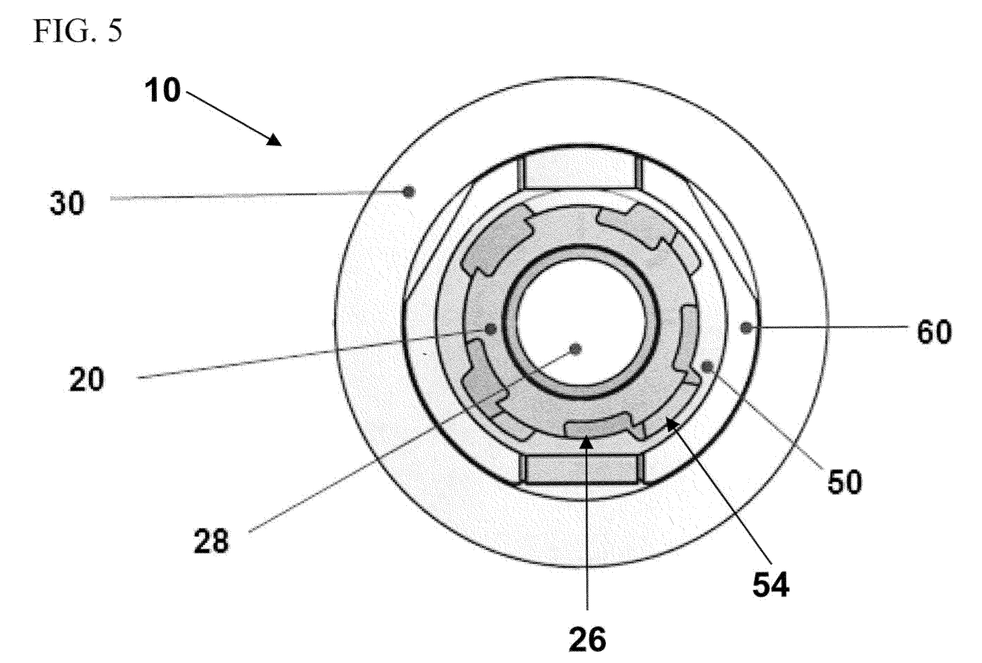

FIGS. 4 and 5 show embodiments of the rotary extrusion die system 10 in which the inner grooves 26 are wider such that wide ribbons are dispensed from the inner grooves 26 instead of strands. The outer grooves 54 also can be wider such that wide ribbons are dispensed from the outer grooves 54 instead of strands.

FIG. 4 shows that the number of the inner grooves 26 can be the same as the number of the outer grooves 54. FIG. 5 shows that the number of the inner grooves 26 can be different than the number of the outer grooves 54.

The size, shape and number of the inner grooves 26 and the size, shape and number of the outer grooves 54 can be varied as desired to achieve the intended cosmetic appearance of the food product. For example, the depth of the inner grooves 26 and/or the depth of the outer grooves 54 can be adjusted to obtain a desired thickness of the corresponding strands.

Accordingly, an aspect of the present disclosure is a rotary extrusion die system comprising an injection inlet that emerges into at least one chamber. A discharge end of the at least one chamber comprises a fixedly positioned inner insert that comprises first grooves and a rotary outer insert that comprises second grooves that circumscribe and/or encircle the first grooves. The fixedly positioned inner insert can be positioned on the axis of rotation of the rotary outer insert. The first grooves can be positioned along a circumference of the external surface of the fixedly positioned inner insert and can face outward from the axis of rotation of the rotary outer insert, and the second grooves can be positioned along a circumference of the inner surface of the rotary outer insert and can face inward toward the axis of rotation of the rotary outer insert. For example, the first grooves can face outward toward the rotary outer insert, and the second grooves can face inward toward the fixedly positioned inner insert. The external surface of the fixedly positioned inner insert can abut the inner surface of the rotary outer insert.

Preferably the first grooves and the second grooves are arranged in concentric circles having a center on the axis of rotation of the outer insert. The fixedly positioned inner insert can comprise an internal channel that extends along the axis of rotation of the rotary outer insert and has an outlet positioned centrally relative to the first and second grooves.

Another aspect of the present disclosure is a method comprising injecting a first edible material into an assembly. Then the first edible material is discharged from the assembly by first grooves that are fixedly positioned and by second grooves that are rotated relative to the first grooves. The first edible material is concurrently discharged from the first and second grooves to form a food product.

The second grooves can circumscribe and/or encircle the first grooves. Preferably the first grooves and the second grooves are arranged in concentric circles having a center on the axis of rotation of the outer insert. The first edible material is preferably continuously injected into the assembly and continuously discharged from the assembly during formation of the food product. The first edible material discharged from the first grooves can form straight strands, and the first edible material discharged from the second grooves can form spiraled strands that overlap the straight strands.

The method can comprise discharging air into a central position relative to the straight and spiraled strands during at least a part of the discharging of the straight and spiraled strands. Additionally or alternatively, the method can comprise discharging a second edible material into a central position relative to the straight and spiraled strands during at least a part of the discharging of the straight and spiraled strands. The second edible material can be a filling for the food product. The second edible material can be a plurality of kibbles.

In an embodiment of the method, the first material forms edible empty shells or edible shells that are filled with meaty kibbles. The shells can be sealed at both open ends. The shells can be solid or be latticed. In an embodiment, a dough is prepared, for example in a horizontal extruder, and then transferred to a vertical rotary extrusion die system to form a hollow cylinder. The cylinder can be fed by gravity to a rotary sealing system. The rotary sealing system can seal the bottom end of the hollow cylinder, for example by using an ultrasonic blade and a counter-blade. Meaty kibbles or small treat pieces can then be filled into this partially-closed cylinder. The top end can then be sealed, for example by the same procedure as the bottom end, to form a closed cylinder with a meaty inner component. In a related embodiment, the cylinder is sealed at both ends without any filling material.

Yet another aspect of the present disclosure is a food product comprising a first edible material, such as a cooked dough, the food product comprising straight strands of the first edible material and spiraled strands of the first edible material. The straight strands can be arranged substantially parallel to each other and at substantially the same distance from a central axis of the food product, and the spiraled strands can form a helix relative to the central axis. The spiraled strands may be positioned at a greater distance from the axis than the straight strands.

The spiraled strands may have gaps between them or, instead, the spiraled strands may be continuous with each other. If the spiraled strands have gaps between them, preferably the width of the gaps is substantially constant. If the spiraled strands are continuous with each other, the sides of each spiraled strand can be in contact with sides of the adjacent spiraled strands along the entire length of the spiraled strand, and preferably the food product comprises an enclosed shell with ridges thereon.

The food product may comprise a second edible material, for example as a filling that can be centrally located relative to the straight strands and the spiraled strands. The straight strands and the spiraled strands may form a cavity in which kibbles of a second edible material are positioned and confined. The spiraled strands may have gaps between them so that the filling or the kibbles can be viewed from the exterior of the food product.

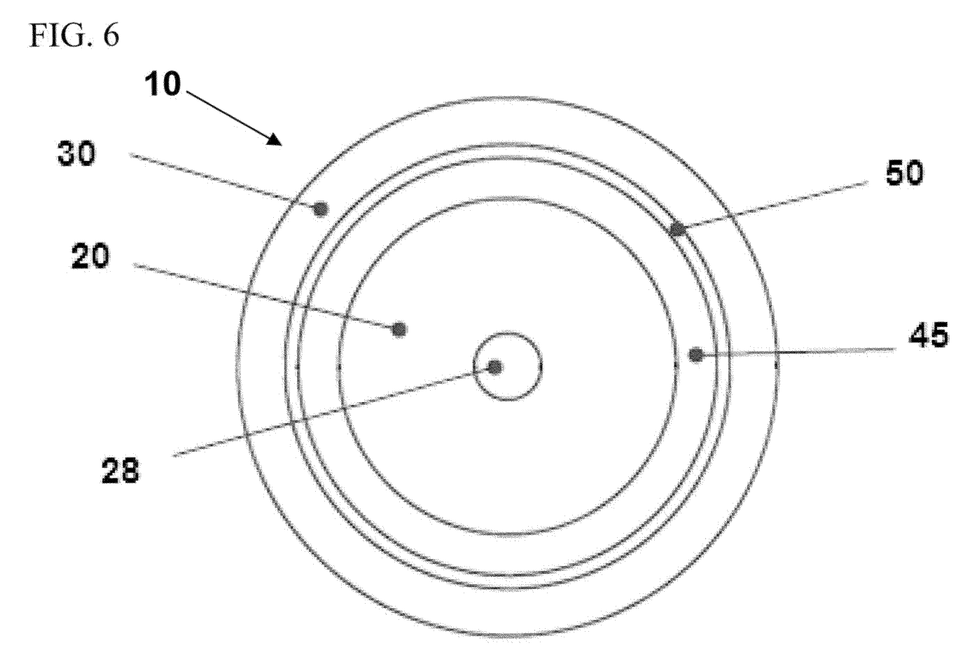

As shown in FIG. 6, solid-walled hollow or filled pieces that can be subsequently sealed may be made with another embodiment of the rotary extrusion die system 10. In this embodiment, the inner grooves 26 and the outer grooves 54 can be absent from the insert inner part 20 and the insert outer part 50 respectively. The discharge end of the rotary extrusion die system 10 can have a gap 45 between the inner insert part 20 and the insert outer part 50. The first edible material can flow through the gap 45 to form solid-walled pieces that are then sealed at one or both ends. The radial width of the gap 45 can be adjusted to obtain a desired thickness of the solid wall of the food product.

A second edible material and/or air can be discharged into the interior of the solid-walled pieces. The second edible material and/or air can be discharged from the additional injection outlet 28 concurrently to at least part of the discharging of the first edible material from the gap 45. For example, flavors and/or colors can be injected into the additional injection inlet 23 and discharged into the interior of the solid-walled pieces from the additional injection outlet 28. As another example, a meaty filling meaty filling and/or a highly viscous dough can be injected into the additional injection inlet 23 and discharged into the interior of the solid-walled pieces from the additional injection outlet 28 to form a filled pillow treat. The diameter of the additional injection outlet 28 can be adjusted to obtain a desired size of the filling, if any. As yet another example, air can be injected into the additional injection inlet 23 and discharged into the interior of the solid-walled pieces from the additional injection outlet 28 to form a hollow pillow treat. The air can prevent the piece from collapsing and can maintain the pillow shape.

Accordingly, an aspect of the present disclosure is a rotary extrusion die system comprising an injection inlet that emerges into at least one chamber, and a discharge end of the at least one chamber can comprise a fixedly positioned inner insert having an outer perimeter and a rotary outer insert having an inner perimeter facing the outer perimeter of the inner insert. The rotary outer insert can be distanced from the fixedly positioned inner insert by a gap between the inner perimeter of the rotary outer insert and the outer perimeter of the inner insert. In an embodiment, the gap is circular. The fixedly positioned inner insert can be positioned on the axis of rotation of the rotary outer insert. The fixedly positioned inner insert can comprise an internal channel that extends along the axis of rotation of the rotary outer insert and has an outlet positioned centrally relative to the inner perimeter of the rotary outer insert and/or the outer perimeter of the inner insert.

Another aspect of the present disclosure is a method comprising injecting a first edible material into an assembly comprising an outer insert and an inner insert and discharging the first edible material from a gap between an inner perimeter of the outer insert and the outer perimeter of the inner insert while rotating at least one of the inner insert or the outer insert. The first edible material is preferably continuously injected into the assembly and continuously discharged from the gap during formation of the food product. The first edible material discharged from the gap can form a shell with a continuous surface.

The method can comprise discharging air into a central position relative to the shell, concurrently to at least part of the discharging of the first edible material from the gap, to form and/or maintain a pillow shape of the shell. The method can comprise discharging a second edible material into a central position relative to the shell concurrently to at least part of the discharging of the first edible material from the gap. In an embodiment, the second edible material forms a filling of the shell. In another embodiment, the second edible material is a plurality of kibbles.

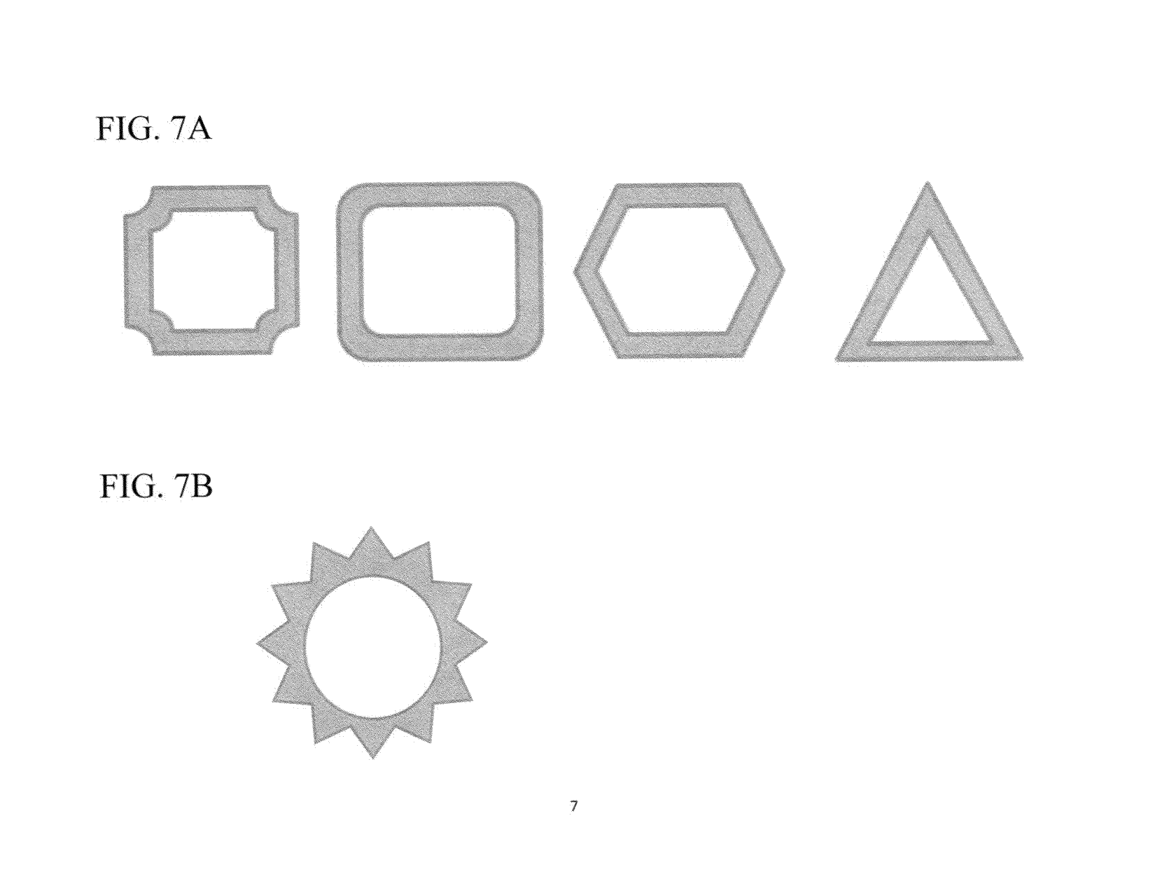

Referring again to the figures, as shown in FIG. 6, the rotary extrusion die system 10 can be configured to produce a food product having a circular cross-section; however, as shown in FIG. 7A, the rotary extrusion die system 10 can be configured to produce a food product having a cross-section of any shape, especially if neither of the insert outer part 50 and the insert inner part 20 are rotated. Furthermore, the surfaces of the inner insert part 20 and the insert outer part 50 which contact the first edible material may be grooved and/or may have another cross-sectional shape which will be reflected on the surface of the extruded material. For example, FIG. 7B shows a cross-section of a food product made with triangular grooves being present in the insert outer part 50 of the embodiment of the rotary extrusion die system 10 shown in FIG. 6. Rotation of at least one of the insert outer part 50 or the insert inner part 20 can form a food product in which the cross-sectional shape spirals around the exterior surface of the food product.

In each of the embodiments of the rotary extrusion die system 10 discussed herein, the first edible material and the second edible material can be any edible material known to one of ordinary skill. For example, the rotary extrusion die system 10 can be used to produce dry, semi-moist and wet pet foods, such as a complete and nutritionally balanced pet food which, in an embodiment, can be for companion animals.

The first edible material and/or any second edible material can be an emulsion, for example an emulsion produced by emulsifying meat with other ingredients. In an embodiment, the emulsion comprises a flour such that the emulsion is a dough. In a preferred embodiment, the first edible material is a cooked dough, optionally with a high viscosity. Examples of suitable flours with which a dough can be made include wheat flour, amaranth flour, bean flour, white or brown rice flour, buckwheat flour, chestnut flour, chickpea flour, potato flour, corn flour, nut flour grated from oily nuts, pea flour, peanut flour, rye flour, tapioca flour, soy flour and the like. Any flour known to the skilled artisan for making a dough can be used.

Meats can be any suitable meat such as poultry, beef, pork, lamb and fish, especially those types of meats suitable for pets. The meat can include any additional parts of an animal including offal. Additionally or alternatively, vegetable protein can be used, such as pea protein, corn protein (e.g., ground corn or corn gluten), wheat protein (e.g., ground wheat or wheat gluten), soy protein (e.g., soybean meal, soy concentrate, or soy isolate), rice protein (e.g., ground rice or rice gluten) and the like. If flour is used, it will also provide some protein. Therefore, a material can be used that is both a vegetable protein and a flour.

The first edible material and any second edible material can comprise vegetable oil, a flavorant, a colorant and water. Suitable vegetable oils include soybean oil, corn oil, cottonseed oil, sunflower oil, canola oil, peanut oil, safflower oil, and the like. Examples of suitable flavorants include yeast, tallow, rendered animal meals (e.g., poultry, beef, lamb, pork), flavor extracts or blends (e.g., grilled beef), and the like. Suitable colorants include FD&C colors, such as blue no. 1, blue no. 2, green no. 3, red no. 3, red no. 40, yellow no. 5, yellow no. 6, and the like; natural colors, such as caramel coloring, mulatto, chlorophyllin, cochineal, betanin, turmeric, saffron, paprika, lycopene, elderberry juice, pandan, butterfly pea and the like; titanium dioxide; and any suitable food colorant known to the skilled artisan.

The first edible material and any second edible material can optionally include additional ingredients, such as other grains and/or other starches additionally or alternatively to flour, amino acids, fibers, sugars, animal oils, aromas, other oils additionally or alternatively to vegetable oil, humectants, preservatives, polyols, salts, oral care ingredients, antioxidants, vitamins, minerals, probiotic microorganisms, bioactive molecules or combinations thereof.

Suitable starches include a grain such as corn, rice, wheat, barley, oats, soy and the like, and mixtures of these grains, and can be included at least partially in any flour. Suitable humectants include salt, sugars, propylene glycol and polyhydric glycols such as glycerin and sorbitol, and the like. Examples of preservatives that can be used include potassium sorbate, sorbic acid, methyl para-hydroxybenzoate, calcium propionate and propionic acid.

Suitable oral care ingredients include alfalfa nutrient concentrate containing chlorophyll, sodium bicarbonate, phosphates (e.g., tricalcium phosphate, acid pyrophosphates, tetrasodium pyrophosphate, metaphosphates, and orthophosphates), peppermint, cloves, parsley, ginger and the like. Examples of suitable antioxidants include butylated hydroxyanisole (“BHA”) and butylated hydroxytoluene (“BHT”), vitamin E (tocopherols), and the like.

Examples of vitamins that can be used include Vitamins A, B-complex (such as B-1, B-2, B-6 and B-12), C, D, E and K, niacin and acid vitamins such as pantothenic acid and folic acid and biotin. Suitable minerals include calcium, iron, zinc, magnesium, iodine, copper, phosphorus, manganese, potassium, chromium, molybdenum, selenium, nickel, tin, silicon, vanadium, boron and the like.

Specific amounts for each additional ingredient will depend on a variety of factors such as the ingredient included in the first edible material and any second edible material; the species of animal; the animal's age, body weight, general health, sex, and diet; the animal's consumption rate; the purpose for which the food product is administered to the animal; and the like. Therefore, the components and their amounts may vary widely.

In an alternative embodiment of the rotary extrusion die system 10, the insert outer part 50 can be fixedly positioned, and the insert inner part 20 or a portion thereof can be configured to rotate relative to the insert outer part 50. In such an embodiment, the spiraled strands can be formed by the inner grooves 26, and the straight strands can be formed by the outer grooves 54.

### EXAMPLES

The following non-limiting examples are illustrative of various embodiments provided by the present disclosure.

### Example 1

200 kg total of hollow soft and chewy sticks were made per the formula shown in Table 1. The dry ingredients and phosphoric acid were blended in a ribbon blender for five minutes. The glycerin and water were held in separate stainless tanks. The blended dry ingredients were fed to a 5 barrel Clextral BC 45 extruder at a rate of 69.4 kg per hour. At the same time, glycerin and water were injected at the throat of the extruder at 16.2 and 14.0 kg/hour respectively, forming cooked viscous dough. The extruder was run at 310 rpm. The cooked dough was pumped into the first forming chamber of the rotary die assembly (FIG. 1/FIG. 2) which was attached to the exit end of the extruder barrel in a horizontal orientation. The inserts were arranged in the rotary die assembly with inserts shown in FIG. 3. As the material moved through the die assembly, the outer inserts were rotated at 100, 200, 300, 400, 600 and 800 rpms and products were collected at each speed. The ropes were cut into 12 cm strips by rotating blades.

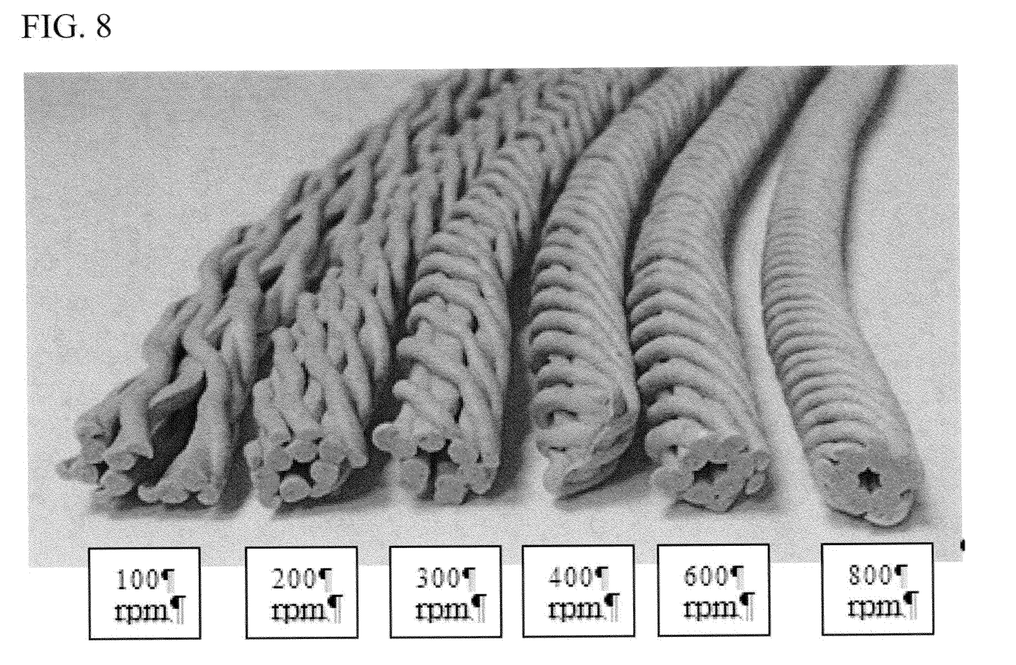

These strips are shown in FIG. 8. It was seen that as the speed of rotation increased, the pitch of the outer coils decreased forming a more tightly packed treat piece. Note there was no center-filling, hence the empty space. At lower speeds (100 and 200 rpm), the strands were not as tightly wound and were easily pulled apart since they were pliable. Moisture of these strips was 14.9% and water activity 0.74.

TABLE 1

| Ingredients | % |
|---|---|
| Meat and Fish Meals | 5.4 |
| Wheat Gluten | 2.1 |
| Pre-gelled Corn Starch | 30.6 |
| Wheat whole grain | 12.5 |
| Fish Oil | 1.5 |
| Sugarbeet pulp | 2.4 |
| Chicory roots | 1.0 |
| Glycerin | 16.2 |
| Sugar Crystalline | 1.8 |
| Water | 14.4 |
| Blend - Vitamins/Minerals/ | 10.1 |
| Flavor/Preservatives | |
| Phosphoric Acid (75%) | 2.0 |
| TOTAL | 100 |

Alternative sources of the ingredients described in Table 2 can also be used, as discussed hereafter. “Meat and Fish Meals” are used as an animal protein source and can be replaced by any “animal by-products” made from carcass, bones, blood, skin, offal, empty intestines, skeletal meat and muscles, or any combination thereof. Meat by-products are obtained from any slaughtered warm-blooded animal including, for example, poultry, bovines, bovines and porcines. Fish by-products are obtained from any wild or farmed fish including white fish, blue fish, salmon and trout.

Wheat gluten is used as a vegetal protein source and can be replaced by other protein sources containing at least 50% in d.s. of crude protein and selected from the group consisting of soy, wheat, millet, buckwheat, rye, sorghum, cassava, lupin, tapioca, corn, rice, bean, lima bean, legumes, pea, chickpea, alfalfa, potato, barley, oat, pre-treated or modified vegetable protein, and combinations thereof. The preferred vegetable protein is wheat gluten.

Pre-gelled starch can be one or more of corn, rice, potato, tapioca or pea. The preferred pre-gel starch is corn and rice, and more preferably extruded pre-gel starch. Wheat whole grain is a native starch source.

Fish oil is a liquid source of fat that may be a mix of different fish oils and can also be replaced by any other animal fat sources, such as poultry fat, beef tallow, pork lard, but also vegetable oils such as soy oil, rapeseed, and the like.

Sugarbeet pulp and chicory roots are fibers sources; any alternative fiber source maybe used, such as pectin sources, cellulose sources, or any soluble or insoluble fiber source.

Glycerin (glycerol) is used as a plasticizer and may be replaced by any of the following components: ethylene glycol, propylene glycol, di-ethylene glycol, tri-ethylene glycol and sugar alcohols. The plasticizer may contain up to 30% by weight of water. The sugar alcohols are selected from the group consisting of sorbitol, glucose, maltitol, xylitol, mannitol, lactitol, erythritol, isomalt, hydrogenated starch hydrolysates, and combinations thereof.

“Sugar crystalline” refers to any crystalline sugar source that acts as a water activity depressing agent.

### Example 2

In this example, 150 kg of filled meaty sticks were made by the following co-extrusion process. The dough (100 kg) for the outer layer (shell) was prepared as in Example 1. 200 kg of second dough for the inner layer (center-filling) were made according to the formula in Table 2.

TABLE 2

| Ingredients | % |
|---|---|
| Meat Meals | 9.2 |
| Wheat Gluten | 5.0 |
| Wheat Flour | 4.3 |
| Pea Fiber | 1.8 |
| Ground Whole Wheat | 42.2 |
| Poultry Fat | 2.2 |
| Liquid Pork Digest | 3.6 |
| Phosphoric Acid (75%) | 0.3 |
| Glycerin | 8.0 |
| Sugar Crystalline | 5.7 |
| Water | 14.1 |
| Vitamins/Minerals/Red | 3.6 |
| Colorant/Flavor | |
| TOTAL | 100 |

The liquid ingredients—poultry fat, liquid pork digest, phosphoric acid, glycerin, water—are weighed into and blended in a stainless steel tank to form a slurry. Slow agitation is maintained to ensure that the slurry is maintained homogenous. Simultaneously, the dry ingredients were weighed into a ribbon blender and mixed until homogenous (five minutes). The slurry and water were held in separate stainless tanks. The blended dry ingredients were fed to a Clextral Evolum 53 twin screw extruder at a rate of 99 kg per hour. At the same time, the slurry and water were each injected at the throat of the extruder at 19.5 kg/hour forming cooked soft meaty dough. The extruder was run at 200 rpm.

The cooked soft meaty dough was pumped into the air/filling injection area of the rotary die assembly (FIG. 1/FIG. 2) which was attached to the exit end of the extruder barrel in a horizontal orientation. The outer layer was made as described in Example 1. The ratio between inner (center filling) layer and outer layer (shell) was 60/40. The total co-extrusion output was 230 kg/hour. Die rotation speed was set based on the linear rope speed (8 m/minute) in order to provide the proper rope cosmetic appearance. To obtain the cosmetic appearance shown in FIG. 9, the rotary die speed was set at about 200 rpm. This speed allowed the lattice that was created to be open enough for the filling to be highly visible. The extruded ropes were cut by rotating blades into strips weighing 20-22 g each (FIG. 9). No drying was required as product was shelf-stable. Final product characteristics: 18% moisture; water activity=0.75%.

Alternative sources of the ingredients described in Table 2 can also be used, as discussed hereafter. Additionally or alternatively to pea fiber, another fiber source may be used, such as pectin sources, cellulose sources, or any soluble or insoluble fiber source. Additionally or alternatively to phosphoric acid, another weak edible acid commonly used for product acidification such as acetic acid, lactic acid, citric acid, and the like may be used. Additionally or alternatively to liquid pork digest, another palatability enhancer such as another type of animal or vegetable digest (hydrolysate) may be used.

For the inner layer (center-filling), instead of the Clextral Evolum 53, a high pressure pump (stuffer) can be used. When a stuffer is used, a cooked meaty dough is formed and then fed to the rotary die by the high pressure pump. The dough is made as follows. The dry ingredients were added to a cooker-blender and as the ribbon element was turning, the liquid was added, forming a paste when combined with the dry ingredients. This paste was heated to 88° C. by direct heat (steam injection) and indirect heat (steam-jacket) and with continuous mixing, to form a soft meaty dough.

### Example 3

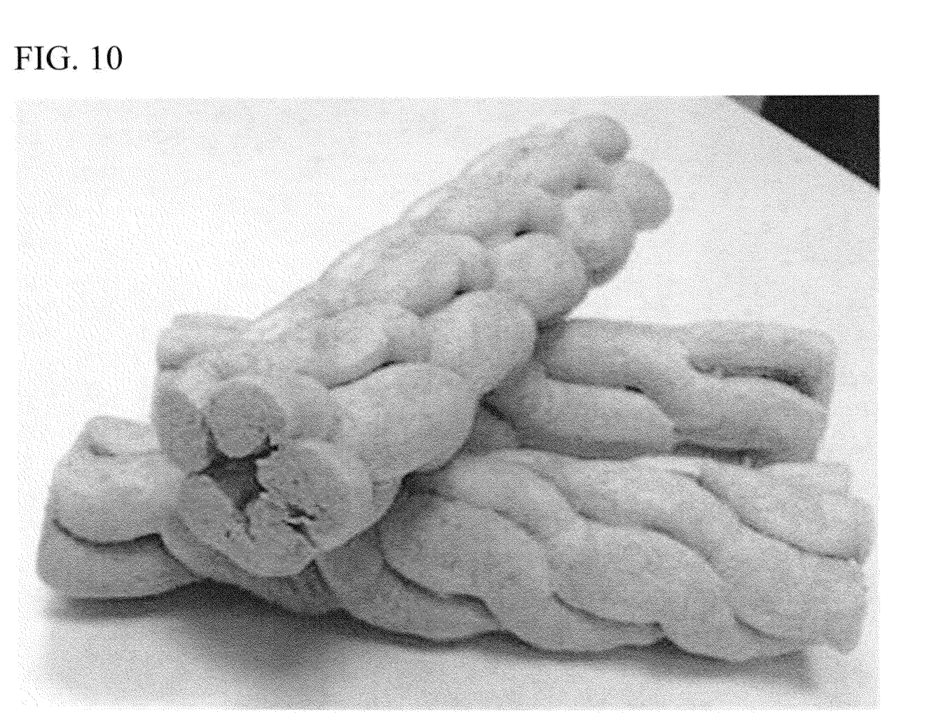

150 kg of stick treats having an outer layer of large expanded strands with aerated and glassy texture, surrounding a hollow center, were made as follows. The procedure was similar to that of Example 1 except that the insert shown in FIG. 5 (creating wider strands) was employed in the rotary die system; the dough was made with formula shown in Table 3 and the fat was mixed with the dry ingredients. Dry mix was metered at 93.6 kg/hour, glycerin at 29.9 kg/hour, and water at 6.5 kg/hour for a total input of 130 kg/h and at an extruder screw speed of 410 rpm. The extruded ropes were cut by rotating blades into strips weighing 88-90 g each (FIG. 10). No drying was required as product was shelf-stable. Final product characteristics: 7% moisture and Δw=0.65.

TABLE 3

| Ingredients | % |
|---|---|
| Pre-gel Starch | 34.8 |
| Wheat Gluten | 2.2 |
| Wheat whole grain | 23.2 |
| Fat | 1.0 |
| Glycerin | 23.0 |
| Water | 5.0 |
| Blend - Vitamins/Minerals/ | 10.8 |
| Flavor/Palatability Enhancers | |
| TOTAL | 100 |

### Example 4

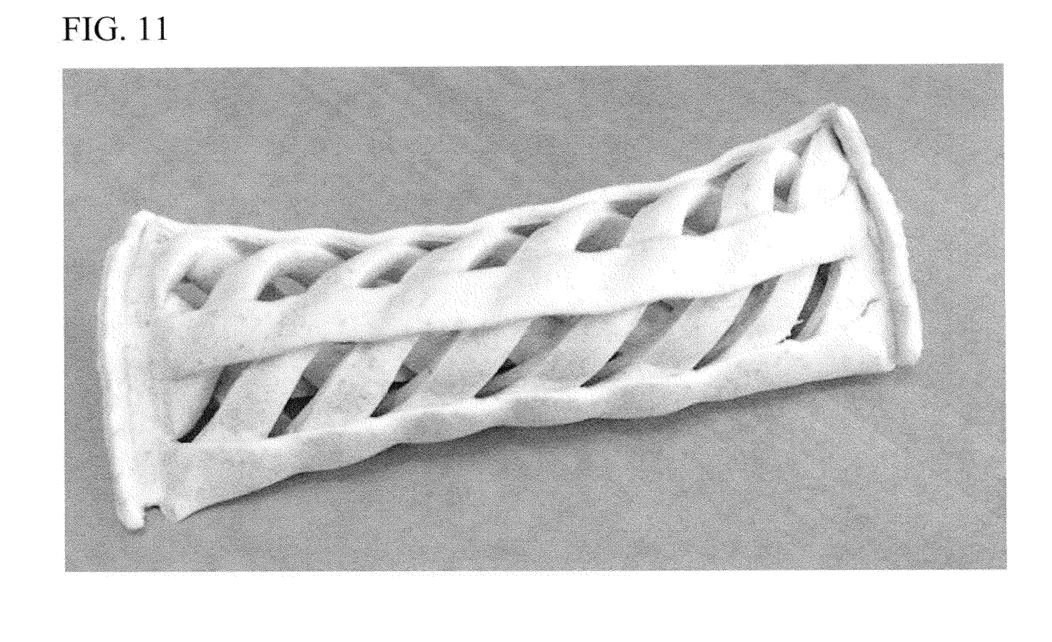

150 kg of hollow pillow-shaped treats were made as in Example 1 according to the formula in Table 4 except for the following. The rotary die assembly was set in a vertical orientation and was fitted with the wider grooved inserts shown in FIG. 4. Additionally the blended dry ingredients were fed to a 10 barrel twin-screw extruder (Evolum 53—Clextral) at a rate of 105 kg/hour; the glycerin was injected at 22.4 kg/hour; and water at 12.6 kg/hour for a total input of 140 kg/hour at a screw speed of 250 rpm. The rotary die speed was 200 rpm, and the hollow tube was crimped and cut immediately on exit with a Dukane Ultrasonic Cutting assembly forming 160 mm long hollow shell (FIG. 11). No drying step was required as product was shelf-stable. Final product characteristics: 8% moisture and water activity=0.70.

TABLE 4

| Ingredients | % |
|---|---|
| Pre-gel Starch | 63.0 |
| Wheat Flour | 4.5 |
| Phosphoric Acid (75%) | 0.5 |
| Glycerin | 16.0 |
| Water | 9.0 |
| Vitamins/Minerals/Flavors/ | 7.0 |
| Preservatives | |
| TOTAL | 100 |

### Example 5

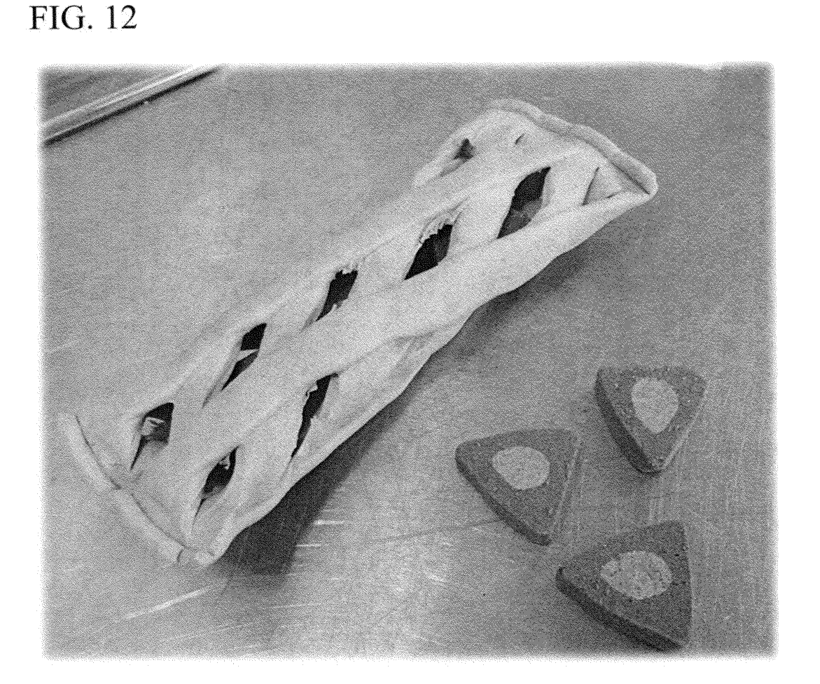

150 kg of kibble-filled pillow-shaped treats were made as follows. Pre-made kibbles were filled in the outer layer (lattice shell) that was made as in Example 4 according to the formula in Table 4. To insert the kibbles, a gravimetric feeder was attached to the air/filling injection area of the rotary die assembly (FIG. 1/FIG. 2). As the outer lattice tube was extruded, the kibbles were deposited in the center by the feeder. Feeding was assisted by compressed air. The system was set so that the lattice tubes exited the die at 3 meters/minute and kibbles filling rate of 100 pieces per minute. The filled ropes were crimped and cut with a Dukane Ultrasonic Cutting assembly in 150 mm pieces. The kibble-filled pillow-shaped treat is shown in FIG. 12.

### Example 6

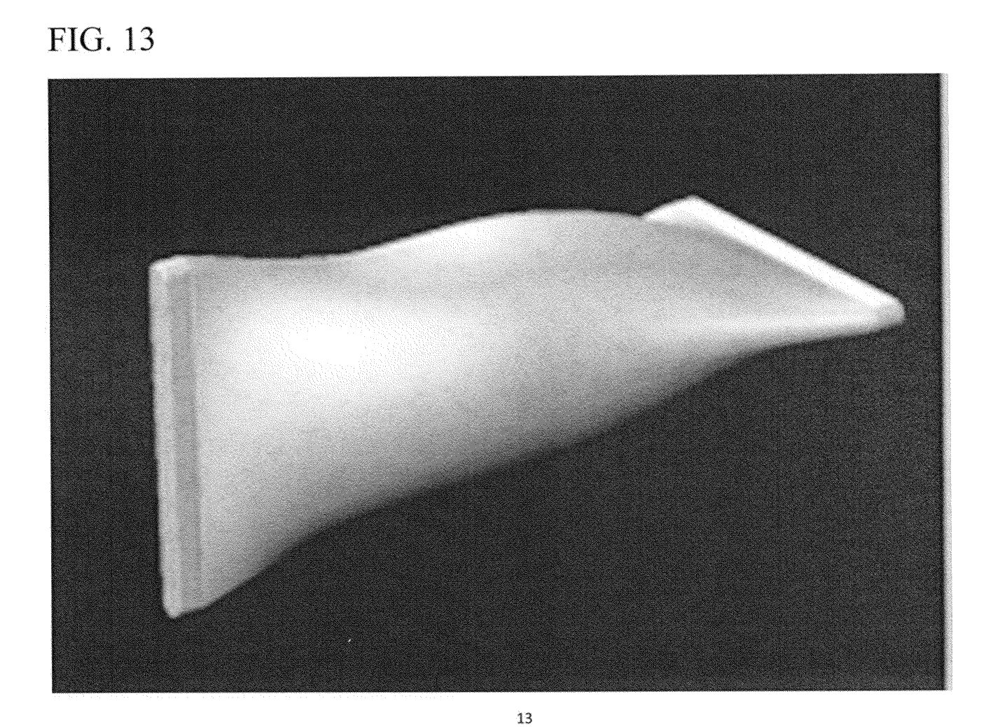

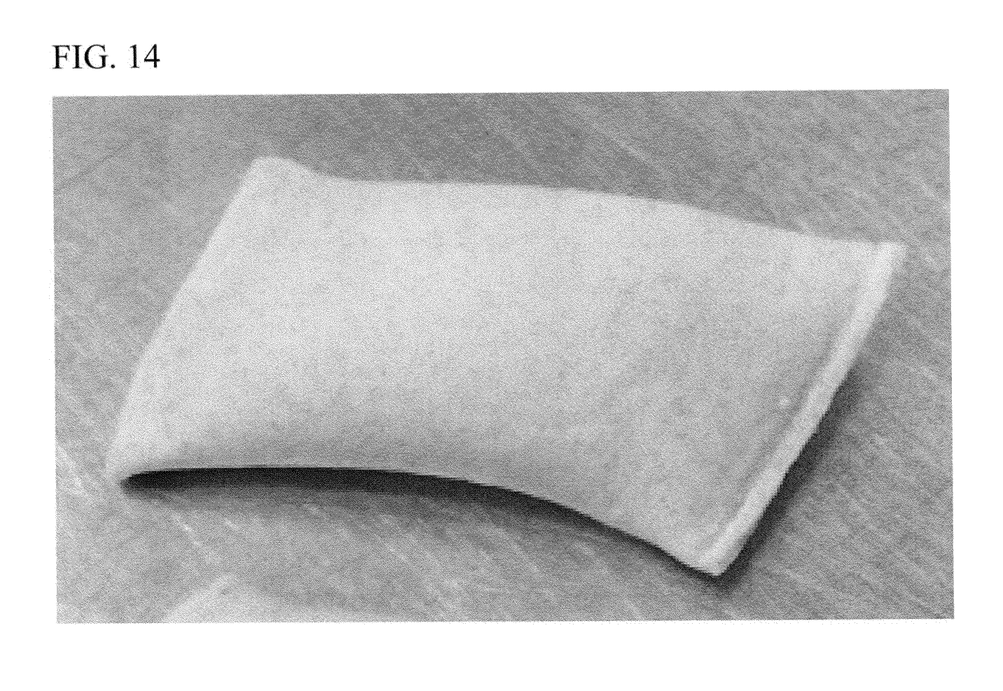

150 kg of hollow pillow-shaped treats were made as in Example 1 according to formula in Table 4 except for the following. The rotary die assembly which was set in a vertical orientation was fitted with inserts that were smooth as shown in FIG. 6. The hollow tube was crimped and cut immediately on exit with a Dukane Ultrasonic Cutting assembly, forming 160 mm long hollow pillows. The orientation of the cut can be varied by the speed of rotation, rotating the cutter, or both to achieve perpendicular or parallel orientation or any angle in between. Pillow-shaped treats resulting from a cutter in perpendicular and parallel orientations are shown in FIGS. 13 and 14 respectively. No drying step was required as the product was shelf-stable. Final product characteristics: 8.5% moisture and water activity=0.70.

### Example 7

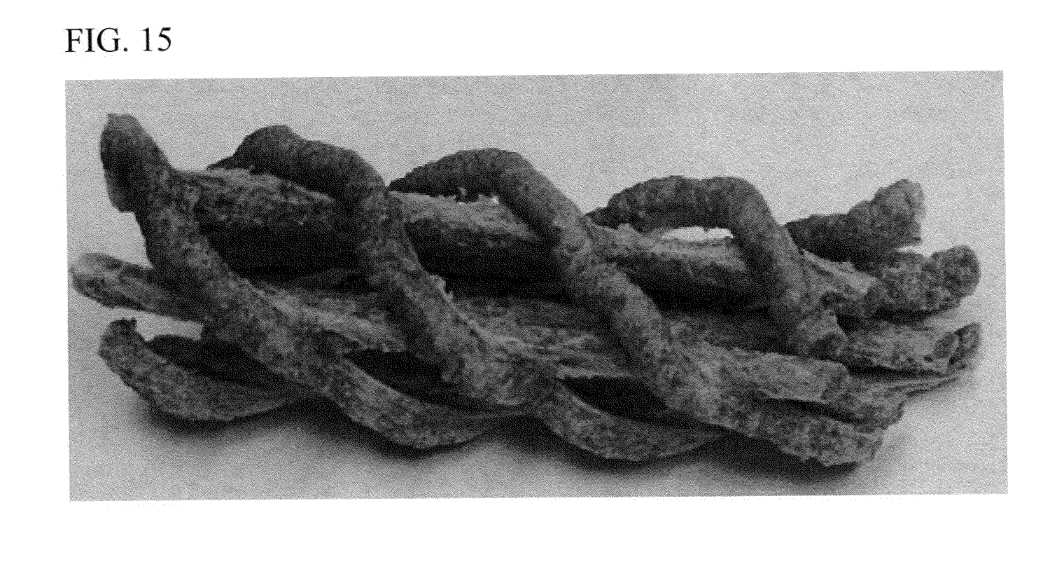

150 kg of crunchy hollow tube pieces were made as in Example 1 per the formula in Table 5 with the following variations. The rotary die assembly (FIGS. 1-3) was attached in a horizontal orientation to a Wenger X-115 single screw extruder with a medium shear screw profile. 1000 kg batch of dry ingredients were blended and fed to the extruder at 866 kg/hour, and at the same time melted fat and water were metered at rates of 94 and 40 kg/hour respectively to the throat of the extruder. The extruder screw speed was 550 rpm, the temperature was 127° C., and the pressure was 41.4 bars. The rotary die was operated at 200 rpm. As the hollow twisted roped product exited the rotary die, the product was cut into 15 cm long pieces with a rotating blade. The pieces were dried in a belt drier (110° C./18 minutes) to a moisture of 5%. 133.5 kg of the dried pieces was coated by spraying with 11.25 kg melted tallow followed by 5.25 kg powdered palatant in a tumble coater. The crunchy treat product is shown in FIG. 15.

TABLE 5

| Ingredients | % |
|---|---|
| Ground Rice | 33.0 |
| Corn Gluten Meal | 13.0 |
| Meat and Fish Meal | 33.6 |
| Animal Fat | 9.4 |
| Water | 4.0 |
| Vitamins/Minerals Flavor and | 7.0 |
| Palatability Enhancers | |
| TOTAL | 100 |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An assembly that forms a food product comprising:
a fixedly positioned insert comprising first grooves that extend to a discharge end of the assembly; and
a rotary insert comprising second grooves that extend to the discharge end of the assembly, and the rotary insert is configured to rotate relative to the fixedly positioned insert.

2. The assembly of claim 1, comprising a chamber in fluid communication with both the first grooves and the second grooves.

3. The assembly of claim 1 wherein the first grooves are arranged along a circle that is concentric to a circle along which the second grooves are arranged, and the center of the circles lies on the axis of rotation of the rotary insert.

4. The assembly of claim 1 wherein the fixedly positioned insert extends along the axis of rotation of the rotary insert, and the first grooves are positioned along a circumference of an external surface of the fixedly positioned insert.

5. The assembly of claim 1 wherein the rotary insert surrounds at least a portion of the fixedly positioned insert, and the second grooves are positioned along a circumference of an internal surface of the rotary insert.

6. The assembly of claim 1 wherein one of the fixedly positioned insert or the rotary insert comprises an internal channel that extends to the discharge end of the assembly.

7. The assembly of claim 1 comprising an injection inlet to which an extruder is attached.

8. The assembly of claim 1 comprising first apertures and second apertures in the discharge end, the first apertures formed by the first grooves and an interior surface of the rotary insert, and the second apertures formed by the second grooves and an exterior surface of the fixedly positioned insert.

9. A method of forming a food product comprising:
injecting a first edible material into an assembly;
discharging, from the assembly, the first edible material as straight strands and as helical strands; and
forming the food product from the straight and helical strands of the first edible material.

10. The method of claim 9, wherein the straight strands of the first edible material are discharged substantially concurrently relative to the helical strands of the first edible material.

11. The method of claim 9, wherein the first edible material is continuously injected into the assembly and continuously discharged from the assembly during formation of the food product.

12. The method of claim 9, wherein the discharging of the first edible material as the straight strands comprises discharging a portion of the first edible material from grooves in a part of the assembly that is fixedly positioned in the assembly.

13. The method of claim 9, comprising rotating a part of the assembly while injecting and discharging the first edible material, and the discharging of the first edible material as the helical strands comprises discharging a portion of the first edible material from grooves in the rotating part of the assembly.

14. The method of claim 9 comprising discharging air into a central position relative to the straight and spiraled strands.

15. The method of claim 9 comprising discharging a second edible material into a central position relative to the straight and spiraled strands.

16. A food product comprising straight strands of a first edible material and spiraled strands of the first edible material, the straight strands arranged substantially parallel to each other and at substantially the same radial distance from a central axis of the food product, and the spiraled strands form a helix around the central axis and overlap the straight strands.

17. The food product of claim 16 wherein the spiraled strands are positioned at a greater radial distance from the central axis than the straight strands.

18. The food product of claim 16 wherein the food product comprises gaps between the spiraled strands.

19. The food product of claim 16 wherein each of the spiraled strands has a length along which the spiraled strand is in contact with adjacent spiraled strands, and the food product comprises an enclosed shell comprising ridges formed by the spiraled strands.

20. The food product of claim 16 comprising a second edible material positioned in an interior of the food product.

21. The food product of claim 16 comprising kibbles confined in a cavity of the food product.

22. The food product of claim 16 wherein the first edible material comprises an ingredient selected from the group consisting of a meat, a flour, and combinations thereof.

23. An assembly that forms a food product comprising:
an inner insert comprising an outer perimeter at a discharge end of the assembly;
an outer insert comprising an inner perimeter that faces the outer perimeter of the inner insert at the discharge end of the assembly, at least one of the inner insert or the outer insert is configured to rotate relative to the other insert on an axis of rotation; and
a gap between the inner perimeter of the outer insert and the outer perimeter of the inner insert at the discharge end of the assembly, the outer insert is distanced from the inner insert by the gap.

24. The assembly of claim 23 wherein the gap is circular and circumscribes the inner insert at the discharge end of the assembly.

25. The assembly of claim 23 wherein the inner insert comprises an internal channel that extends along the axis of rotation.

26. A method of forming an edible shell comprising:
injecting a first edible material into an assembly comprising an inner insert and an outer insert;
discharging the first edible material from the assembly by discharging the first edible material from a gap that is between an inner perimeter of the outer insert and the outer perimeter of the inner insert;
rotating at least one of the inner insert or the outer insert relative to the other insert while discharging the first edible material from the gap; and
forming the edible shell from the first edible material that is discharged from the gap during the rotation.

27. The method of claim 26 wherein the first edible material is continuously injected into the assembly and continuously discharged from the gap during formation of the edible shell.

28. The method of claim 26 comprising discharging air into an interior of the shell from a channel in the inner insert.

29. The method of claim 26 comprising discharging a second edible material into an interior of the shell from a channel in the inner insert.

30. The method of claim 26 wherein the gap is circular and circumscribes the inner insert.
